(19) United States
(12) Patent Application Publication
(10) Pub. No.: US 2024/0265332 A1
(43) Pub. Date: Aug. 8, 2024

(54) QUALITY MANAGEMENT APPARATUS, QUALITY MANAGEMENT METHOD AND PROGRAM

(71) Applicant: NIPPON TELEGRAPH AND TELEPHONE CORPORATION, Tokyo (JP)

(72) Inventors: Shmuel UR, Galil (IL); Ziv GLAZBERG, Ramat Gan (IL); Ran LEHR, Tel-Aviv (IL); Erez KEINAN, Rishon Le-zion (IL)

(73) Assignee: NIPPON TELEGRAPH AND TELEPHONE CORPORATION, Tokyo (JP)

(21) Appl. No.: 18/563,529

(22) PCT Filed: May 27, 2021
(86) PCT No.: PCT/JP2021/020311

§ 371 Date: Nov. 22, 2023

(51) Int. Cl. G06Q 10/0639; G06Q 10/067

(52) U.S. Cl. CPC G06Q 10/06395; G06Q 10/067

(57) ABSTRACT

A quality management apparatus includes a processor configured to collect work information of a plurality of workers who perform software development; create a base model serving as a base for evaluation of work quality on the basis of the work information of the plurality of workers; and evaluate work quality of a worker on the basis of the base model and a model based on work information of the worker.

### TECHNICAL FIELD

The present invention relates to a technique for evaluating work quality in software development.

### BACKGROUND ART

In a software development project, a project manager needs to grasp and control work quality such as the work speed of a worker and the number of bugs. Meanwhile, in recent years, due to an increase in crowdsourcing and the like, workers often perform development work in remote environments.

In a case of a worker who performs development in a remote environment, it is difficult to sufficiently grasp the work quality as compared with a worker who works together with a project manager on site for a long period of time.

### CONVENTIONAL ART LITERATURE

### Non Patent Literature

Non Patent Literature 1: “An Open Source Simulation Model of Software Development and Testing”, Shmuel Ur1, Elad Yom-Tov1, and Paul Wernick2 http://www.yom-tov.info/Papers/OpenSourceSoftwareModeling.pdf

### SUMMARY OF INVENTION

### Problem to be Solved by Invention

Non Patent Literature 1 discloses a technique of constructing a simulation model in a programming and test phase of a software development project and evaluating the effectiveness of a development strategy such as pair programming or test automation. However, the technique disclosed in Non Patent Literature 1 cannot evaluate the work quality of a worker who performs development in a remote environment.

The present invention has been made in view of the above points, and an object thereof is to provide a technique capable of appropriately evaluating the work quality of a worker in software development.

### Means to Solve Problem

According to the disclosed technique, there is provided a quality management apparatus including:
an information collection unit that collects work information of a plurality of workers who performs software development;
a model creation unit that creates a base model serving as a base for evaluation of work quality on the basis of the work information of the plurality of workers; and
an evaluation unit that evaluates work quality of a worker on the basis of the base model and a model based on work information of the worker.

### Advantageous Effects of Invention

According to the disclosed technique, it is possible to appropriately evaluate the work quality of a worker in software development.

### BRIEF DESCRIPTION OF DRAWINGS

FIG. 1 is a diagram illustrating an overall configuration example of a system according to an embodiment of the present invention.

FIG. 2 is a diagram illustrating a configuration example of a quality management apparatus.

FIG. 3 is a flowchart of an operation.

FIG. 4 is a diagram for describing an example of evaluation.

FIG. 5 is a diagram for describing an example of evaluation.

FIG. 6 is a diagram illustrating a hardware configuration example of an apparatus.

### MODE FOR CARRYING OUT INVENTION

Hereinafter, an embodiment of the present invention (present embodiment) will be described with reference to the drawings. The embodiment to be described below is merely an example, and an embodiment to which the present invention is applied is not limited to the following embodiment. Furthermore, in the following description, unless otherwise specified, “code” and “program” are used synonymously. That is, “code” appearing in the following description may be replaced with “program”.

In addition, in the following description, it is assumed that workers perform software development (code development) in remote environments, but the technique according to the present invention is applicable not only to development in remote environments.

### Outline of Embodiment

In the present embodiment, a quality management apparatus 100 to be described later monitors work performed by workers in remote environments, and collects work information of the workers (for example, information regarding work quality). The quality management apparatus 100 creates a model for each worker by analysis and creates a model serving as a base for evaluation. Creating the base model and the model for each worker makes it possible to compare the work quality between the workers. Furthermore, creating the model makes it possible to predict work quality expected from a worker.

### (System Configuration Example)

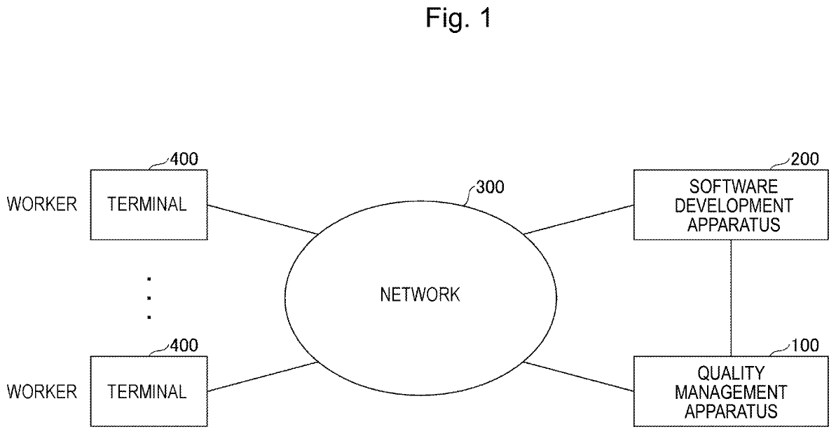

FIG. 1 illustrates an overall configuration example of a system according to the embodiment of the present invention. As illustrated in FIG. 1, the present system has a configuration in which a plurality of terminals 400, the quality management apparatus 100, and a software development apparatus 200 are connected to a network 300 such as the Internet.

Each of the terminals 400 is a terminal for a worker in a remote environment to perform software development. The software development apparatus 200 is an apparatus for software development having a debugging function, a code execution function, and the like. Each of the terminals 400 performs code creation, debugging, and the like by accessing the software development apparatus 200.

The quality management apparatus 100 collects, from the software development apparatus 200 (or the terminals 400), information regarding work quality in software development performed by each worker (each of the terminals 400) with respect to the software development apparatus 200, creates a model to be described later on the basis of the collected information, and evaluates the work quality of each worker. Note that the quality management apparatus 100 may include the software development apparatus 200.

### (Configuration Example of Quality Management Apparatus 100)

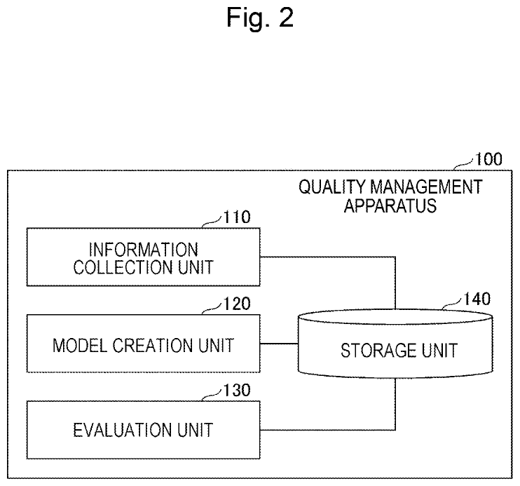

FIG. 2 illustrates a configuration example of the quality management apparatus 100. As illustrated in FIG. 2, the quality management apparatus 100 includes an information collection unit 110, a model creation unit 120, an evaluation unit 130, and a storage unit 140. A functional outline of each unit is as follows.

The information collection unit 110 collects information regarding work quality in software development of each worker. The model creation unit 120 creates a model on the basis of the information collected by the information collection unit 110. The model creation unit 120 also creates a base model.

The evaluation unit 130 evaluates the work quality of each worker on the basis of the model created by the model creation unit 120, and outputs an evaluation result. The storage unit 140 stores the information collected by the information collection unit 110, the model created by the model creation unit 120, the evaluation result by the evaluation unit 130, and the like.

The quality management apparatus 100 may be physically configured by one apparatus (computer) or may be configured by a plurality of apparatuses connected to a network. For example, the information collection unit 110 in the quality management apparatus 100 may be provided in each of the terminals 400 of the workers, and the model creation unit 120, the evaluation unit 130, and the storage unit 140 may be provided in a remote server. The server may be a virtual machine on a cloud.

In the case where the information collection unit 110 is provided in each of the terminals 400 of the workers, the information regarding the work quality is collected by each of the terminals 400, and the collected information is stored in the storage unit 140 in the server via the network 300 and used for model creation and the like.

### (Operation Example of Quality Management Apparatus 100)

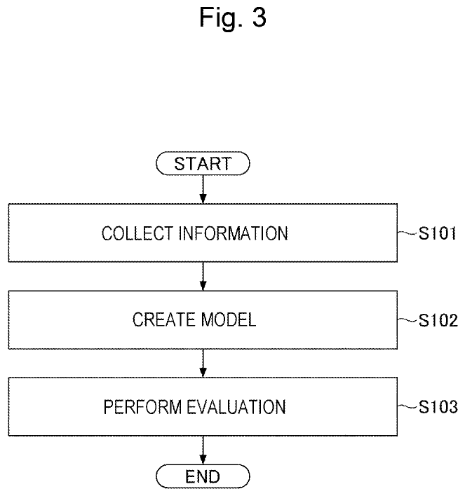

Hereinafter, an operation example of the quality management apparatus 100 will be described along the procedure of the flowchart illustrated in FIG. 3. Note that, in the following example, it is assumed that information regarding work quality is acquired from the software development apparatus 200.

### <S101: Information Collection>

Workers access the software development apparatus 200 by their terminals 400 to perform code creation, debugging, testing, and the like. The information collection unit 110 collects information regarding work quality in software development for each worker from the software development apparatus 200, and stores the collected information in the storage unit 140.

The information regarding the work quality is, for example, information regarding the speed of code creation (for example, the number of lines of code created per hour), information regarding accuracy (for example, the number of bugs per line of code), a time taken to correct bugs, and the like. Each item of the collected (measured) information may be referred to as a parameter.

In addition, the information collection unit 110 may collect raw information such as created lines and occurrence of bugs, and process and analyze the raw information to calculate the number of lines of code created per hour, the number of bugs per line of code, and the like. Furthermore, the information collection unit 110 may collect and store raw information such as created lines and occurrence of bugs, and in S102, the model creation unit 120 may process and analyze the raw information to calculate the number of lines of code created per hour, the number of bugs per line of code, and the like.

Furthermore, the information regarding the work quality is not limited to the work of the code creation process, and may be, for example, quality information regarding document creation in a design process or quality information regarding test execution in a test process.

### <S102: Model Creation, S103: Evaluation>

In S102, the model creation unit 120 creates a model of the work quality of each worker on the basis of the collected information, and in S103, the evaluation unit 130 evaluates the work quality of each worker on the basis of the model of each worker and a base model, which is an average model. Note that “evaluating” includes outputting information regarding the model of each worker and information regarding the base model.

Note that the evaluation executed in the process illustrated in FIG. 3 is continuously performed for a certain task (project). In addition, the above base model may be created in advance before creation of the model of each worker, or may be created in parallel with creation of the model of each worker.

By the evaluation in S103, the speed of the code creation work of a worker, the quality of the code, an expected risk, and the like can be evaluated. For example, a project manager may adjust the scope, duration, risk, or the like of the project on the basis of these evaluation results. Such adjustment is continuously performed in association with progress of the project, participation of a new worker, or the like.

### <Detailed Example of Model and Evaluation>

The “model” of each worker is a set of values (parameter values) measured (collected) for each worker. In addition, the value of each parameter may be referred to as a “model”.

The model creation unit 120 creates the base model serving as a base of evaluation of the model of each worker. The base model may be referred to as a reference model.

The model creation unit 120 uses, for example, a set of average values of parameters for a plurality of workers as a base model. For example, it is assumed that there are workers A, B, and C, and there are parameters X, Y, and Z as parameters. Here, assuming that the average value of the workers A to C for the parameter X is 1, the average value of the workers A to C for the parameter Y is 2, and the average value of the workers A to C for the parameter Z is 5, the base model is created as “parameter X=1, parameter Y=2, and parameter Z=5”.

Note that using average values for a plurality of workers for the creation of the base model is an example. Statistical values other than average values for a plurality of workers may be used.

Furthermore, a weight may be given to each of the parameters. For example, an important parameter is assigned a higher weight.

For example, the evaluation unit 130 calculates a rank (evaluation value) of work quality by multiplying, for each parameter, the weight of the parameter by the value of the parameter and adding the obtained values together. Note that the rank may also be referred to as a “model”.

For example, in a case of the weight of the parameter X=0.2, the weight of the parameter Y=0.5, and the weight of the parameter Z=0.1, assuming that the model of a certain worker is “parameter X=1, parameter Y=1, and parameter Z=2”, the rank of the worker is 1×0.2+1×0.5+2×0.1=0.9. Note that such a method of calculating a rank is an example.

Performing the above calculation for the base model makes it possible to obtain a rank serving as a base. For example, assuming that the base model is “parameter X=1, parameter Y=2, and parameter Z=5”, the rank serving as a base is 1×0.2+2×0.5+5×0.1=1.7. As an example, the evaluation unit 130 can output the comprehensive work quality of a certain worker by comparing the rank of the worker with the rank serving as a base. For example, information indicating that the work quality of the worker is superior to that of the base model can be output.

Note that a rank (evaluation value) may be calculated for each parameter. For example, assuming that the parameter X=1 and its weight is 0.2, the rank for the parameter X is 0.2.

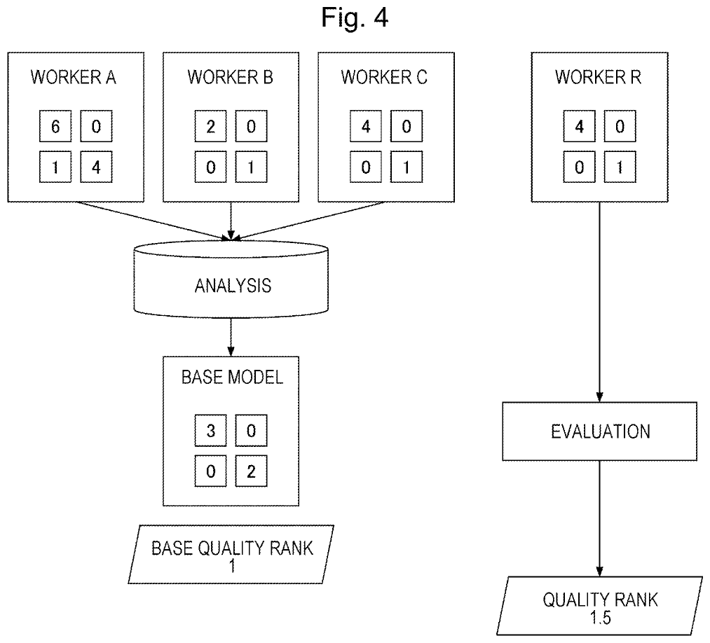

FIG. 4 is a diagram illustrating an example of a case where evaluation is performed by the above-described processing. In the example of FIG. 4, there are workers A, B, C, and R, and the values of four parameters are collected for each worker. Here, the model creation unit 120 creates a base model by analyzing (for example, calculating averages of) the values of the parameters of the workers A, B, and C. Furthermore, the evaluation unit 130 obtains a rank serving as a base (1 in this case) by multiplying, for each parameter, the weight of the parameter by the value of the parameter and adding the obtained values together. In addition, in a case where the evaluation target is the worker R, the rank for the worker R (1.5 in this case) is obtained. In this example, it can be seen that the rank for the worker R is higher than the rank serving as a base.

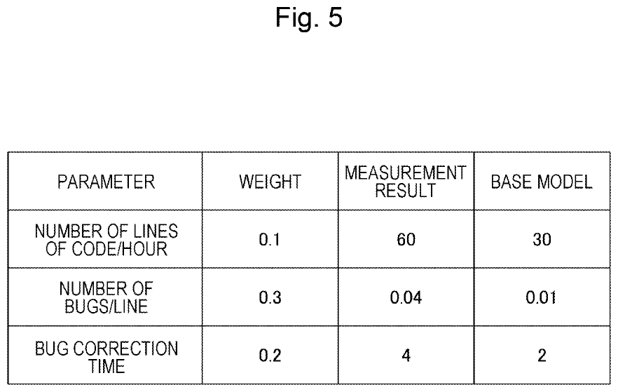

FIG. 5 illustrates a more specific example. FIG. 5 illustrates collected information (measurement results) of the worker R with respect to three parameters (number of lines of code created per hour, number of bugs per line, and bug correction time), the weight of each parameter, and the value of each parameter in the base model.

For example, when the number of lines of code created per hour by the worker R is compared with the number of lines code created per hour in the base model, the evaluation unit 130 can output an evaluation indicating that the worker R can write a code much faster than the base model. However, when the values of the other parameters are compared, it is evaluated that the number of bugs by the worker R is larger than that in the base model, and the worker R spends more time to correct the bugs.

In the example of FIG. 5, the weights of the parameters related to the bugs are higher than the weight of the parameter related to the speed of code creation. It can be seen that the worker R is inferior to the base model in the values related to the parameters having higher weights (higher importance).

### (Hardware Configuration Example of Apparatus)

The quality management apparatus 100 can be implemented, for example, by causing a computer to execute a program. This computer may be a physical computer, or may be a virtual machine on a cloud.

That is, a program corresponding to processing performed by the quality management apparatus 100 is executed by use of hardware resources such as a CPU and a memory built in a computer, so that the quality management apparatus 100 can be implemented. The above program can be stored and distributed by being recorded in a computer-readable recording medium (portable memory or the like). The above program can also be provided through a network such as the Internet or email.

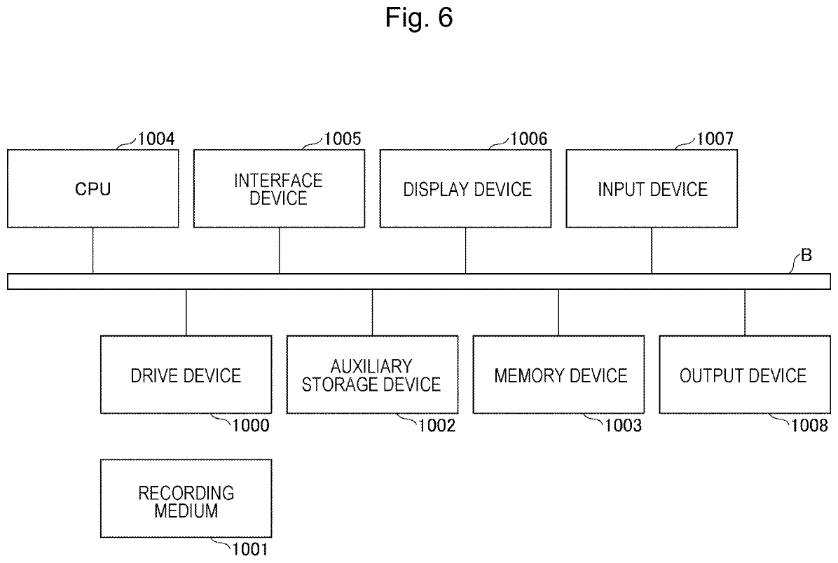

FIG. 6 is a diagram illustrating a hardware configuration example of the above computer. The computer in FIG. 6 includes a drive device 1000, an auxiliary storage device 1002, a memory device 1003, a CPU 1004, an interface device 1005, a display device 1006, an input device 1007, an output device 1008, and the like, which are connected to each other by a bus BS.

The program for implementing processing in the computer is provided through a recording medium 1001 such as a CD-ROM or a memory card, for example. When the recording medium 1001 storing the program is set in the drive device 1000, the program is installed from the recording medium 1001 into the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to start the program is made, the memory device 1003 reads the program from the auxiliary storage device 1002, and stores the program therein. The CPU 1004 implements a function related to the quality management apparatus 100 in accordance with the program stored in the memory device 1003. The interface device 1005 is used as an interface for connection to a network, various external devices, and the like. The display device 1006 displays a graphical user interface (GUI) or the like according to the program. The input device 1007 includes a keyboard and a mouse, buttons, a touch panel, or the like, and is used to input various operation instructions. The output device 1008 outputs a calculation result.

### Advantageous Effects of Embodiment

As described above, according to the technique of the present embodiment, information regarding work performance of workers who perform software development is continuously collected, analyzed, and modeled, and the work quality of each worker is evaluated on the basis of the model. Therefore, it is possible to evaluate the work performance ability of each worker necessary for management of progress and resources particularly in remote development.

### SUMMARY OF EMBODIMENT

The present specification discloses at least a quality management apparatus, a quality management method, and a program described in the following clauses.

### (Clause 1)

A quality management apparatus including: an information collection unit that collects work information of a plurality of workers who perform software development; a model creation unit that creates a base model serving as a base for evaluation of work quality on the basis of the work information of the plurality of workers; and an evaluation unit that evaluates work quality of a certain worker on the basis of the base model and a model based on work information of the worker.

### (Clause 2)

The quality management apparatus according to clause 1, wherein the software development by the workers is performed by terminals placed in remote environments.

### (Clause 3)

The quality management apparatus according to clause 1 or 2, wherein a weight is assigned to each of parameters constituting the model, and the evaluation unit calculates a rank by multiplying, for each of the parameters, the weight of a parameter by a value of the parameter and adding values obtained for all the parameters together.

### (Clause 4)

The quality management apparatus according to clause 3, wherein the evaluation unit evaluates work quality of the worker by comparing a rank based on the base model with a rank based on a model of the worker.

### (Clause 5)

The quality management apparatus according to any one of clauses 1 to 4, wherein a plurality of parameters constituting the model include a number of lines of code created per unit time, a number of bugs per line, and a bug correction time.

### (Clause 6)

A quality management method executed by a quality management apparatus, the quality management method including: a step of collecting work information of a plurality of workers who perform software development; a step of creating a base model serving as a base for evaluation of work quality on the basis of the work information of the plurality of workers; and a step of evaluating work quality of a certain worker on the basis of the base model and a model based on work information of the worker.

### (Clause 7)

A program for causing a computer to function as each unit in the quality management apparatus according to any one of clauses 1 to 5.

Although the present embodiment has been described above, the present invention is not limited to such a specific embodiment, and various modifications and changes can be made within the scope of the gist of the present invention described in the claims.

### DESCRIPTION OF REFERENCE SIGNS

100 Quality management apparatus
110 Information collection unit
120 Model creation unit
130 Evaluation unit
140 Storage unit
200 Software development apparatus
300 Network
400 Terminal
1000 Drive device
1001 Recording medium
1002 Auxiliary storage device
1003 Memory device
1004 CPU
1005 Interface device
1006 Display device
1007 Input device
1008 Output device

1. A quality management apparatus comprising a processor configured to:
collect work information of a plurality of workers who perform software development;
create a base model serving as a base for evaluation of work quality on a basis of the work information of the plurality of workers; and
evaluate work quality of a worker on a basis of the base model and a model based on work information of the worker.

2. The quality management apparatus according to claim 1, wherein the software development by the workers is performed by terminals placed in remote environments.

3. The quality management apparatus according to claim 1, wherein
a weight is assigned to each of parameters included in the model, and the the processor is configured to calculate a rank by multiplying, for each of the parameters, the weight of a parameter by a value of the parameter and adding values obtained for all the parameters together, the parameter being from among the parameters.

4. The quality management apparatus according to claim 3, wherein
the processor is configured to calculate work quality of the worker by comparing a rank based on the base model with a rank based on a model of the worker.

5. The quality management apparatus according claim 1, wherein
a plurality of parameters included in the model include a number of lines of code created per unit time, a number of bugs per line, and a bug correction time.

6. A quality management method executed by a processor, the quality management method comprising:
collecting work information of a plurality of workers who perform software development;
creating a base model serving as a base for evaluation of work quality on a basis of the work information of the plurality of workers; and
evaluating work quality of a worker on a basis of the base model and a model based on work information of the worker.

7. A non-transitory computer-readable recording medium storing a program for causing a computer to:
collect work information of a plurality of workers who perform software development;
create a base model serving as a base for evaluation of work quality on a basis of the work information of the plurality of workers; and
evaluate work quality of a worker on a basis of the base model and a model based on work information of the worker.
